(19) United States
(12) Patent Application Publication
(10) Pub. No.: US 2007/0041701 A1
(43) Pub. Date: Feb. 22, 2007

(54) Light guide plate and a backlight system

(75) Inventors: Xing-Peng Yang, Beijing (CN); Guo-Fan Jin, Beijing (CN); Ying-Bai Yan, Beijing (CN); Di Feng, Beijing (CN); Hai-Tao Liu, Beijing (CN); Qiao-Feng Tan, Beijing (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignees: Tsinghua University, Beijing City (CN); HON HAI PRECISION INDUSTRY CO., LTD., Tu-Cheng City (TW)

(21) Appl. No.: 11/266,042

(22) Filed: Nov. 3, 2005

Related U.S. Application Data
(63) Continuation-in-part of application No. 11/207,104, filed on Aug. 18, 2005.

(51) Int. Cl. G02B 6/10

(52) U.S. Cl. 385/146

(57) ABSTRACT

A backlight system includes a light guide plate and a light source. The light guide plate includes a light incident surface, a reflective surface adjoining the light incident surface, and a light-emitting surface opposite to the reflective surface. The light guide plate further includes an upper layer and a lower layer under the upper layer. The upper layer includes a substrate portion, a light-emitting surface, a second surface, and a number of projections. The projections extend from the second surface. Each projection has a top extremity adjoining the substrate portion and a bottom face distal from the substrate portion. The lower layer includes a light incident surface, a top surface adjoining the light incident surface, and a reflective surface opposite to the top surface. The top surface of the lower layer abuts the bottom face of the projections.

### CROSS-REFERENCE TO RELATED APPLICATIONS

This application is a continuation-in-part of U.S. patent application Ser. No. 11/207,104, filed Aug. 18, 2005, entitled “LIGHT GUIDE DEVICE AND BACKLIGHT MODULE USING THE SAME” by Di Feng et al., the disclosure for which is hereby incorporated herein in its entirety by reference.

### TECHNICAL FIELD

The present invention relates to flat panel display devices, and more particularly to a light guide plate (LGP) and a backlight system using an LGP in a flat panel display device.

### BACKGROUND

Flat panel display devices include, for example, liquid crystal display (LCD) devices, plasma display devices, and electroluminescence devices. The liquid crystal display device has been used very widely as the display of choice for portable electronic equipment such as mobile information terminals and notebook type personal computers. The liquid crystal display device is also used in home electronic equipment such as word processors and personal computers.

A typical liquid crystal display device includes an LCD panel, and a backlight system mounted under the LCD panel for supplying light beams thereto. Referring to FIG. 10, a typical backlight system 10 includes a light source 12, a light guide plate (LGP) 11, a reflector 13, a diffuser sheet 14, and a pair of perpendicularly crossed brightness-enhancing films (BEFs) 15. The light source 12 is typically located adjacent one edge of the LGP 11, to minimize the thickness of the liquid crystal display device. The LGP 11 is generally flat with a uniform thickness, or wedge shaped. In the illustrated embodiment, the LGP 11 is wedge shaped, and includes a light incident surface 111, a bottom surface 112 adjoining the light incident surface 111, a light-emitting surface 113 opposite to the bottom surface 112, and a side surface 114 opposite to the light incident surface 111. The reflector 13 is positioned under the bottom surface 112 and side surface 114, to prevent light from escaping out from the bottom surface 112. The diffuser sheet 14 is disposed on the light-emitting surface 113, to enhance a uniformity of display light provided by the backlight system. The BEFs 15 are disposed on the diffuser sheet 14 to enhance display brightness.

In operation, the light source 12 emits light beams, which are directed into the LGP 11. The reflector 13 reflects at least some of the light beams diffusely. This tends to result in inferior directionality of light beams output from the LGP 11, and unduly high power consumption. Thus, the two BEFs 15 are employed to improve to a certain degree the directionality of light beams output from the backlight system. However, the BEFs 15 may increase the cost of the backlight system, and do not necessarily decrease power consumption.

In order to solve the above-mentioned problems, microstructures can be formed on the light-emitting surface of an LGP. For example, a number of inverted trapezoid projections can be thus formed by molding. However, in general, forming of the microstructures by molding can be problematic. For example, it can be difficult to separate the formed LGP from the mold. Consequently, an inclined angle of each of two opposite sides of each trapezoid projection needs to be configured to promote easy separation of the formed LGP from the mold. Thus the range of inclined angles of said sides of each projection is limited. Because of this limitation, it is difficult to configure the projections so that said sides have inclined angles that provide desired directionality of light output from the light-emitting surface. As a result, the uniformity of light intensity on the light-emitting surface and the brightness of the backlight system may be less than optimal.

What is needed, therefore, is an LGP having projections that can be readily configured to control directions of output light beams, wherein the LGP can be conveniently molded.

What is also needed is a backlight system with an LGP that has high luminance and uniform distribution of light intensity at a light-emitting surface thereof, wherein the LGP can be conveniently molded.

### SUMMARY

A light guide plate in accordance with a preferred embodiment of the present invention includes an upper layer, and a lower layer under the upper layer. The upper layer includes a substrate portion, and a number of projections. The substrate portion has a light-emitting surface and a second surface opposite to the light-emitting surface. The projections extend from the second surface. Each of the projections has a top extremity adjoining the second surface and a bottom face distal from the second surface. The bottom face has a surface area smaller than an area of the top extremity. The lower layer includes a light incident surface, a top surface adjoining the light incident surface, and a reflective surface opposite to the top surface. The top surface of the lower layer abuts the bottom face of the projections.

In another preferred embodiment of the present invent, a backlight system includes the light guide plate described above, and a light source. The light source is disposed adjacent the light incident surface of the light guide plate.

Preferably, the nearer the projections are to the light incident surface, the lower the distribution density and/or dimensions of the projections. The distribution density and/or dimensions of the projections varies according to periodic intervals along a length of the upper layer. Each periodic interval has a length in the range from about 10 micrometers to about 150 micrometers.

The bottom face of each projection preferably has a width in the range from 10 micrometers to 60 micrometers. A ratio of a width of the top extremity to a height of each projection is in the range from about 1:2 to about 2:1, and is preferably about 1:1.

Each projection has two elongate side surfaces generally parallel to the light incident surface of the lower layer. The side surfaces may be selected from a group consisting of a plane surface, a folded surface, and a curved surface. When each side surface is a plane surface, an angle between the side surfaces and an imaginary line normal to the light-emitting surface of the light guide plate is in the range from 10 degrees to 45 degrees.

In addition, the light incident surface and/or the reflective surface define a plurality of grooves, the grooves being arranged side by side from one lateral side of the lower layer to an opposite lateral side of the lower layer. The V-shaped grooves may have a groove depth less than 100 micrometers, and defines a groove angle in the range from about 60 degrees to about 140 degrees. Moreover, dimensions of the V-shaped grooves can be changed at a length period of 10 micrometers to 100 micrometers.

Compared with conventional light guide plates, the light guide plate of the preferred embodiment employs a number of projections extending from an opposite surface to the light-emitting surface of the upper layer, and in combination with the bottom face of each projection having a smaller surface area than that of the top extremity. It is advantageous that the upper layer can be readily formed by way of an injection molding method, an etching method, or a splicing method. In the case of an injection mold process, the formed upper layer can be readily separated from the mold. In addition, by controlling inclined angles of side surfaces of the projections to an imaginary normal of the light-emitting surface of the LGP, the output direction of light emitting from light guide plate can be flexibly controlled to be suitable for the desired direction, for example, generally substantially perpendicular to the light-emitting surface.

The backlight system, in the preferred embodiment of the invention, has a bright luminance and an uniform distribution of the power intensity on the light-emitting surface by employing the light guide plate above-mentioned. Furthermore, the backlight system is free of prisms and has the advantages of low cost and a compact structure.

Other advantages and novel features will be drawn from the following detailed description of preferred embodiments when taken conjunction with the attached drawings, in which:

### BRIEF DESCRIPTION OF THE DRAWINGS

FIG. 1 is a simplified, side plan view of a backlight system according to a preferred embodiment of the present invention, the backlight system comprising a light source and a light guide plate (LGP);

FIG. 2 is an isometric, inverted view of an upper layer of the LGP of FIG. 1;

FIG. 3A is an enlarged, side plan view of one projection on the upper layer of LGP of FIG 1;

FIG. 3B is an enlarged, side plan view of two projections of an upper layer of an LGP according to an alternative embodiment of the present invention;

FIG. 3C is an enlarged, side plan view of two projections of an upper layer of an LGP according to another alternative embodiment of the present invention;

FIG. 4 is a simplified, side plan view of a backlight system according to an alternative embodiment of the present invention, showing projections of an upper layer of an LGP thereof configured with a varying distribution density;

FIG. 5 is an isometric view of a lower layer of the LGP of FIG. 1, showing V-shaped grooves formed at a light incident surface thereof;

FIG. 6 is an isometric view of a lower layer of an LGP according to an alternative embodiment of the present invention, showing V-shaped grooves formed at a light incident surface thereof and at a bottom reflective surface thereof;

FIG. 7 is a simplified, side plan view of the LGP of FIG. 1, but showing a reflective film formed on a bottom surface of a substrate portion of the upper layer of the LGP;

FIG. 8 is similar to FIG. 7, but showing a reflective film also formed on side surfaces of projections of the upper layer of the LGP;

FIG. 9 is similar to FIG. 8, but showing a reflective film also formed on a bottom reflective surface of a lower layer of the LGP, and a reflective film also formed on an end surface of the lower layer of the LGP, and showing the light source of FIG. 1; and

FIG. 10 is a simplified, exploded, isometric view of a conventional backlight system.

### DETAILED DESCRIPTION OF THE EMBODIMENTS

Embodiments of the present invention will now be described in detail below with reference to the drawings.

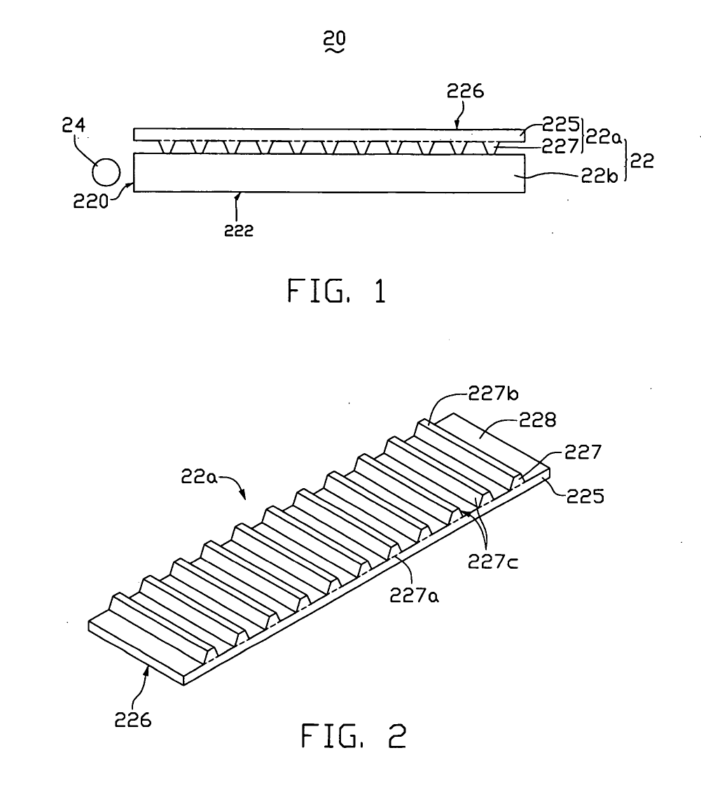

Referring to FIG. 1, in a preferred embodiment of the present invention, a backlight system 20 of a display device generally include a plate-like light guide member 22 and a light source 24. The light guide plate 22 generally includes a light incident surface 220, a reflective surface 222 adjoining the light incident surface 220, and a light-emitting surface 226 opposite to the reflective surface 222. The light guide plate 22 may further define two layer structures; i.e., an upper layer 22a, and a lower layer 22b underlying the upper layer 22a. A side surface and a bottom surface of the lower layer 22b respectively constitute the light incident surface 220 and the reflective surface 222. A top surface of the upper layer 22a constitutes the light-emitting surface 226.

The light source 24 is generally disposed adjacent to the light incident surface 220. The light source 24 may generally be a point light source or a linear light source; for example, a light-emitting diode, a cold cathode fluorescent lamp, or a fluorescent tube. In the preferred embodiment, the light source 24 is an array of light-emitting diodes that effectively constitutes a linear light source.

Referring to FIG. 2, the upper layer 22a includes a substrate portion 225, and a number of projections 227. The substrate portion 225 may be comprised of a transparent material selected from the group consisting of polymethyl methacrylate (PMMA) resin, polycarbonate (PC) resin, and glass. The substrate portion 225 includes the light-emitting surface 226 and a bottom surface 228. The projections 227 extend from the bottom surface 228. The projections 227 are elongate, parallel to each other, and substantially parallel to the light incidence surface 220 (see FIG. 1).

Each of the projections 227 defines a top extremity 227a (a planar portion, indicated by a dashed line in FIG. 2), a bottom face 227b, and two opposite, elongate side surfaces 227c. The top extremity 227a is essentially coplanar with the bottom surface 228 of the substrate portion 225. The bottom face 227b is preferably parallel to the bottom surface 228. A surface area of the bottom face 227b is less than an area of the top extremity 227a. The upper layer 22a contacts the top surface of the lower layer 22b (see FIG. 1) via the bottom faces 227b.

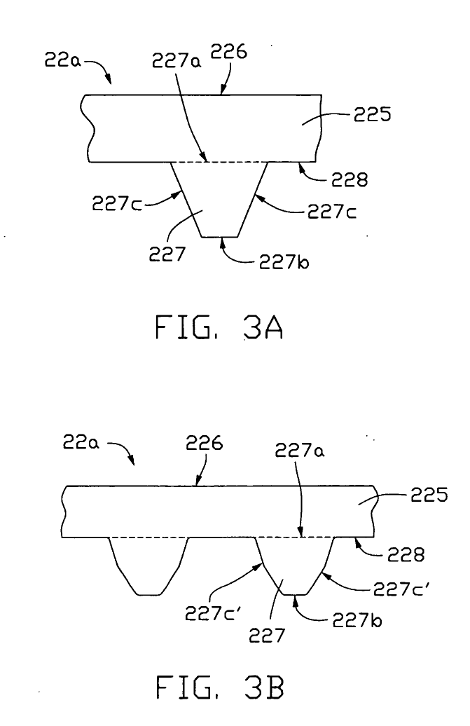

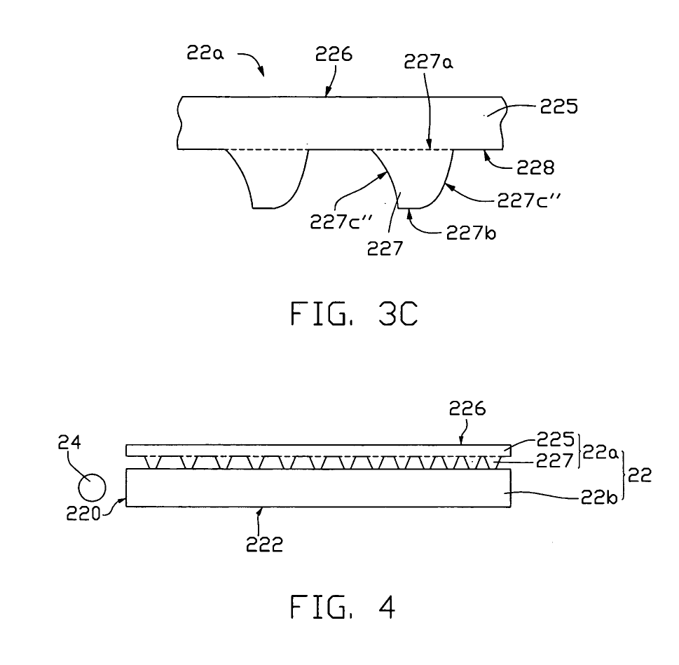

Referring also to FIG. 3A, each side surface 227c of each projection 227 is plane. That is, a cross-section of each projection 227 is an inverted trapezoid. Alternatively, each projection 227 may define other kinds of side surfaces. For example, referring to FIG. 3B, each projection 227 may define a pair of folded surfaces 227c′, in which each folded surface 227c′ comprises two of more adjoining plane surfaces. In another example, referring to FIG. 3C, each projection 227 may define a pair of curved surfaces 227c″. Depending on fabrication techniques and the desired light output direction, each folded surface 227c′ may have the plane surfaces thereof oriented at suitable angles, and may define a suitable angle between each two adjoining plane surfaces. Similarly, each curved surface 227c″ may be convex or concave, and may have a desired curvature. For example, each projection 227 may have one concave curved surface 227c″ and one convex curved surface 227c″, with each curved surface 227c″ having a desired curvature.

Preferably, a width of the bottom face 227b is less than a width of the top extremity 227a of each projection 227. Preferably, the bottom face 227b has a width in the range from about 10 micrometers to about 60 micrometers. A ratio of a width of the top extremity 227a to a height of the projection 227 may be in the range from about 1:2 to about 2:1, and is preferably about 1:1. An angle between each side surface 227c and an imaginary line normal to the light-emitting surface 226 of the light guide plate 22 is in the range from 10 degrees to 45 degrees, and is preferably about 30 degrees.

Generally, by controlling the distribution density and/or the dimensions of the projections 227, the uniformity of output light can be improved. For example, FIG. 4 shows a backlight system in accordance with an alternative embodiment of the present invention. In the backlight system, the nearer the projections 227 are to the light source 24, the lower the distribution density of the projections 227. Alternatively, the distribution density of the projections 227 may vary according to periodic intervals along a length of the upper layer 22a. A length of each periodic interval, and a degree of change of distribution density from one periodic interval to an adjacent periodic interval, are preferably determined in order to avoid optical interference and in order to avoid users being able to discern the existence of the projections with the naked eye. For example, each periodic interval may have a length in the range from about 10 micrometers to about 150 micrometers.

It is advantageous that the upper layer 22a including the projections 227 can be readily formed by way of an injection molding method, an etching method, or a splicing method. In the case of an injection mold process, the formed upper layer 22a can be readily separated from the mold.

Referring to FIG. 5, in order to improve the efficiency of incident light beams coupling into the light incident surface 220, the light incident surface 220 defines a number of first grooves 221a. Each first groove 221a may, for example, be V-shaped. The first grooves 221a are parallel to one another, and are arranged side by side along the light incident surface 220. Each of the first grooves 221a has a groove depth D of less than 100 micrometers. Each of the first grooves 221a defines a groove angle θ. The groove angle θ is in the range from about 60 degrees to about 140 degrees, and is preferably about 120 degrees. Alternatively, the configurations of the first grooves 221a may vary according to periodic intervals along a length of the light incident surface 220. A length of each periodic interval, and a type and degree of change of configuration from one periodic interval to an adjacent periodic interval, are preferably determined in order to avoid optical interference and in order to avoid users being able to discern the existence of the first grooves 221a with the naked eye. For example, each periodic interval may have a length in the range from about 10 micrometers to about 100 micrometers.

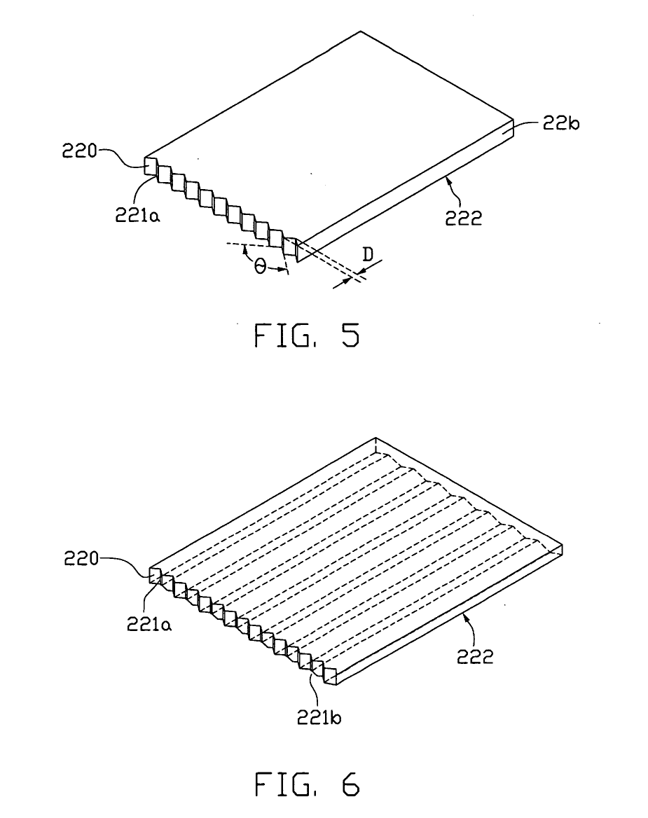

Referring to FIG. 6, further, the reflective surface 222 defines a number of second grooves 221b. Each second groove 221b may, for example, be V-shaped. The second grooves 221b are elongate, are parallel to one another, and are arranged side by side from one lateral side of the reflective surface 222 to an opposite lateral side of the reflective surface 222. The configuration(s) and dimension range(s) of the second grooves 221b may be similar to those of the first grooves 221a.

The first grooves 221a are substantially perpendicular to the second grooves 221b. Depending on different desired light output directions, the grooves 221a and 221b may optionally have dimensions different from those described above. For example, the groove depth D and/or the groove angle θ can be varied as needed. In particular, by controlling the configuration of the first grooves 221a, a uniformity of light entering the lower layer 22b via the light incident surface 220 can be enhanced. As a result, the appearance of “shadows” on the light-emitting surface 226 of the light guide plate 22 can be reduced or even eliminated. Similarly, by controlling the configuration of the second grooves 221b, directions of light output from the top surface of the lower layer 22b can be suitably controlled.

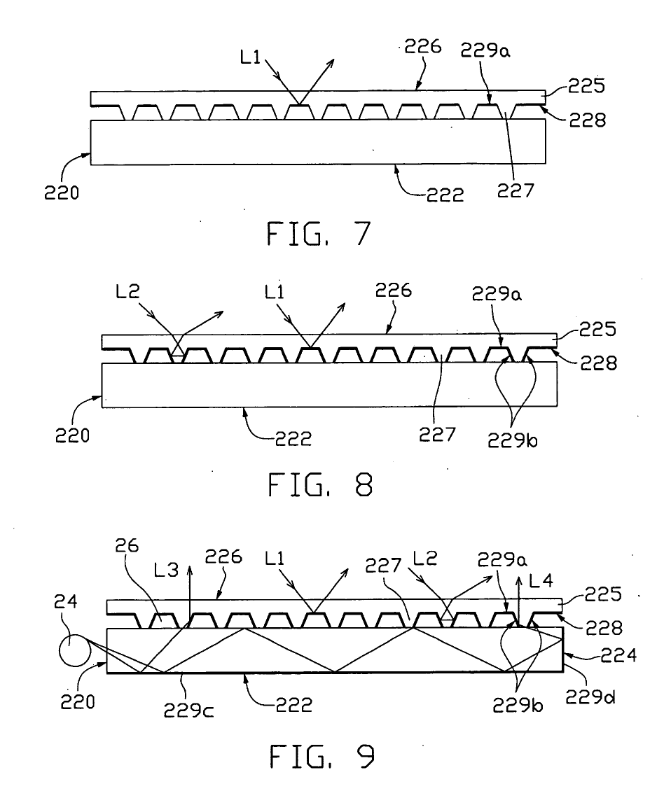

Referring to FIG. 7, a reflecting film 229a can be formed on the bottom surface 228 of the substrate portion 225 between each two adjacent projections 227. The reflecting film 229a is formed by a deposition method. The reflecting film 229a can reflect light beams from the ambient environment back toward the light-emitting surface 226. For example, a light beam L1 as shown in FIG. 8 can be thus reflected.

Referring to FIG. 8, a reflecting film 229b can be formed on the side surfaces 227c of the projections 227. The reflecting film 229b is provided in addition to the reflecting film 229a. The reflecting film 229b can reflect other light beams from the ambient environment back toward the light-emitting surface 226, in addition to the light beams reflected by the reflecting film 229a. For example, a light beam L2 as shown in FIG. 9 can be thus reflected.

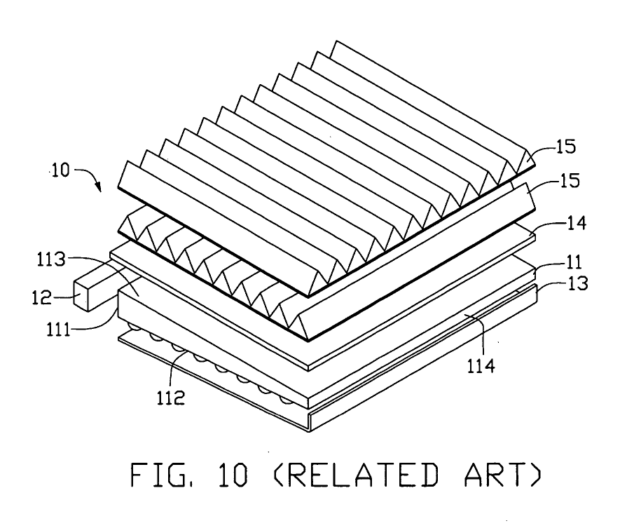

Referring to FIG. 9, the lower layer 22b has an end surface 224 opposite to the incident surface 220. Reflecting films 229c, 229d can be formed on the reflective surface 222 and the end surface 224 respectively. The reflecting films 229c, 229d can prevent light beams (e.g., light beams L3, L4 as shown in FIG. 10) from escaping from the reflective surface 222 and the end surface 224. Due to utilization of the reflecting films 229c, 229d, the backlight system 20 does not need reflectors attached on the light guide plate 22.

Each of the reflecting films 229a, 229b, 229c, 229d may be a metal film; for example, an aluminum film or a silver film. By providing the reflecting films 229a, 229b, 229c, 229d on the surfaces 228, 227c, 222, 224, the efficiency of utilization of light energy in the backlight system 20 can be improved. Further, the backlight system 20 can achieve both transmission illumination and reflection illumination.

Moreover, referring to FIG. 9 again, the upper layer 22a and the lower layer 22b define a number of interspaces 26 therebetween. The interspaces 26 are separated from one another by the projections 227. The interspaces 26 are filled with a low refractive index material; for example, air or an inert gas.

It will be understood that the particular means and methods shown and described are provided by way of illustration only, and not as limiting the invention. The principles and features of the present invention may be employed in various and numerous embodiments thereof without departing from the scope of the invention as claimed. The above-described embodiments illustrate the scope of the invention but do not restrict the scope of the invention.

1. A light guide plate comprising:
an upper layer comprising:
a substrate portion having a light-emitting surface and a second surface opposite to the light-emitting surface; and
a plurality of projections extending from the second surface, each projection defining a top extremity adjoining the second surface and a bottom face distal from the second surface, the bottom face having a surface area smaller than an area of the top extremity; and
a lower layer under the upper layer, the lower layer comprising:
a light incident surface;
a top surface adjoining the light incident surface, the top surface abutting the bottom faces of the projections; and
a reflective surface opposite to the top surface;
wherein the nearer the projections are to the light incident surface, the lower a distribution density of the projections.

2-3. (canceled)

4. The light guide plate as claimed in claim 1, wherein the bottom face of each projection has a width in the range from 10 micrometers to 60 micrometers.

5. The light guide plate as claimed in claim 1, wherein a ratio of a width of the top extremity to a height of each projection is in the range from about 1:2 to about 2:1.

6. The light guide plate as claimed in claim 1, wherein each of the projections defines two elongate side surfaces, and each side surface is selected from the group consisting of a plane surface, a folded surface, and a curved surface.

7. The light guide plate as claimed in claim 6, wherein each side surface is a plane surface, and an angle between the side surface and an imaginary line normal to the light-emitting surface is in the range from 10 degrees to 45 degrees.

8. The light guide plate as claimed in claim 1, wherein at least one of the light incident surface and the reflective surface defines a plurality of grooves, the grooves being arranged side by side from one lateral side of the lower layer to an opposite lateral side of the lower layer.

9. The light guide plate as claimed in claim 8, wherein the grooves are V-shaped.

10. The light guide plate as claimed in claim 9, wherein each of the V-shaped grooves has a groove depth less than 100 micrometers, and defines a groove angle in the range from about 60 degrees to about 140 degrees.

11. The light guide plate as claimed in claim 6, wherein the lower layer further comprises an end surface opposite to the light incident surface, and one or more reflecting films are formed on one or more surfaces selected from the group consisting of the end surface, the second surface, the side surfaces, and the reflective surface.

12. A backlight system comprising:
a light guide plate comprising:
an upper layer comprising:
a substrate portion having a light-emitting surface and a second surface opposite to the light-emitting surface, the second surface coated with a reflecting metal film; and
a plurality of projections extending from the second surface, each projection defining a top extremity adjoining the second surface, a bottom face distal from the second surface, and two elongate side surfaces, the bottom face having a surface area smaller than an area of the top extremity, and each side surface coated with a reflecting metal film; and
a lower layer under the upper layer, the lower layer comprising;
a light incident surface;
a top surface adjoining the light incident surface, the top surface abutting the bottom faces of the projections; and
a reflective surface opposite to the top surface; and
a light source disposed adjacent the incident surface of the light guide plate.

13. The backlight system as claimed in claim 12, wherein the nearer the projections are to the light incident surface, the lower a distribution density of the projections.

14-16. (canceled)

17. The backlight system as claimed in claim 12, wherein each side surface of each projection is selected from the group consisting of a plane surface, a folded surface, and a curved surface, and the bottom face of each projection has a width in the range from 10 micrometers to 60 micrometers.

18. The backlight system as claimed in claim 17, wherein each side surface is a plane surface, and an angle between the side surface and an imaginary line normal to the light-emitting surface is in the range from 10 degrees to 45 degrees.

19. The backlight system as claimed in claim 12, wherein at least one of the light incident surface and the reflective surface defines a plurality of grooves, the grooves being arranged side by side from one lateral side of the lower layer to an opposite lateral side of the lower layer.

20. A display device comprising:
a light source; and
a light guide member disposed next to said light source, and comprising a first layer and a second layer adjacently separable from said first layer, said first layer capable of receiving light from said light source and transmitting said light toward said second layer, said second layer comprising at least two projections extending therefrom toward said first layer and optically coupling with said first layer so as to accept said light transmitted by said first layer into said second layer exclusively via said at least two projections, each of said at least two projections having an extending distal area thereof adjacent to said first layer less than an extending base area thereof around said second layer, and the nearer said at least two projections being to said light source, the lower a distribution density of said at least two projections.

21. The display device as claimed in claim 20, wherein each of the projections defines two elongate side surfaces, and each side surface is selected from the group consisting of a plane surface, a folded surface, and a curved surface.

22. The display device as claimed in claim 21, wherein each of the side surfaces is coated with a reflecting metal film.

23. The display device as claimed in claim 20, wherein each of the projections defines a bottom face parallel to the second layer and having a width in the range from 10 micrometers to 60 micrometers.

24. The backlight system as claimed in claim 12, wherein the lower layer further comprises an end surface opposite to the light incident surface, and one or more reflecting films are formed on one or more surfaces selected from the group consisting of the end surface of the lower layer, the second surface of the upper layer, and the reflective surface of the lower layer.
